(19) United States
(12) Patent Application Publication
(10) Pub. No.: US 2005/0201266 A1
(43) Pub. Date: Sep. 15, 2005

(54) Optical disc recordable drive

(75) Inventor: Zheng-Tie Sun, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/070,215

(22) Filed: Mar. 3, 2005

(30) Foreign Application Priority Data
Mar. 12, 2004 (TW) 93106766

(51) Int. Cl. G11B 7/24

(52) U.S. Cl. 369/292; 369/30.23; 712/1

(57) ABSTRACT

An optical disc recordable drive including a first transmission interface, a data encoding unit, a data register unit, a data recording unit and a controlling unit is provided. The first transmission interface is for coupling with a second transmission interface of an electronic device. The data encoding unit is for coding a first data outputted by an electronic device and accordingly outputting a second data. The data register unit is for storing the second data outputted by the data encoding unit. The data recording unit is for recording the second data stored in the data register unit onto an optical disc. The controlling unit is for controlling the electronic device to output first data to the data encoding unit and controlling the operation of the data encoding unit, the data register unit and the data recording unit.

This application claims the benefit of Taiwan application Serial No. 93106766, filed Mar. 12, 2004, the subject matter of which is incorporated herein by reference.

### BACKGROUND OF THE INVENTION

1. Field of the Invention

The invention relates in general to an optical disc recordable drive, and more particularly to an optical disc recordable drive for coding and recording a first data of an electronic device onto an optical disc.

2. Description of the Related Art

With the rapid advance in science and technology and the popularity in pictures, music, movies and computer software, the optical disc with high capacity has become an important software carrier to modern people. Besides, the optical disc drive for reading or recording a CD has thus become an essential item for computers.

When the user would like to back-up the data stored in a data CD to another blank CD, first of all, the user needs to respectively place a data CD and a blank CD on a CD-ROM and a CD-R. Both the CD-ROM and the CD-R are coupled with the computer. Next, the user activates a data recording command to the computer. After that, when the computer's CPU uses the received data recording command to control the CD-R for recording the data stored in data CD placed in a CD-ROM onto a blank CD to complete the recording process.

Despite today's CD-ROM and CD-R can be externally connected to a computer, the computer is still required for recording the data stored in data CD placed in the CD-ROM onto a blank CD. Since computer is not convenient to carry with, the user cannot use computer to record the to-be-recorded data stored in the data CD placed in a CD-ROM onto an optical disc via a CD-R. Especially along with the booming development of multi-media information industry, various multi-media recording devices are available in the market like mushrooms after rain. Take digital camera for example, when the memory card of a digital camera is full, the user cannot bring a computer and CD-R with him/her for recording the data stored in the memory card of the digital camera, so the user has to spend some more money to prepare additional memory cards.

### SUMMARY OF THE INVENTION

It is therefore a object of the invention to provide an optical disc recordable drive, whose design of coupling with an electronic device via a plug/unplug type transmission interface such as a USB or IEEE 1394 is free of complicated design like a computer has and enables the user to back-up data whenever and wherever the user would like to.

According to an object of the invention, an optical disc recordable drive including a first transmission interface, a data encoding unit, a data register unit, a data recording unit and a controlling unit is provided. The first transmission interface is for coupling with a second transmission interface of an electronic device. The data encoding unit is for coding a first data outputted by an electronic device and accordingly outputting a second data. The data register unit is for storing the second data outputted by the data encoding unit. The data recording unit is for recording the second data stored in the data register unit onto an optical disc. The controlling unit is for controlling the electronic device to output first data to the data encoding unit and controlling the operation of the data encoding unit, the data register unit and the data recording unit.

According to another object of the invention, an optical disc recordable drive, including a data encoding unit, a data register unit, a data recording unit, a controlling unit and a first transmission interface is provided. The first transmission interface is for coupling with a second transmission interface of an electronic device via a protocol, so that a user can control the optical disc recordable drive via an electronic device. The data encoding unit is for coding a first data outputted by an electronic device and accordingly outputting a second data. The data register unit is for storing the second data outputted by the data encoding unit, the data recording unit is for recording the second data stored in the data register unit onto an optical disc. The controlling unit is for controlling the operation of the data encoding unit, the data register unit and the data recording unit. The user controls optical disc recordable drive via the electronic device, so that the optical disc recordable drive can code and record the first data outputted by the electronic device onto an optical disc.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a circuit diagram of an optical disc recordable drive and electronic device according to a preferred embodiment of the invention.

### DETAILED DESCRIPTION OF THE INVENTION

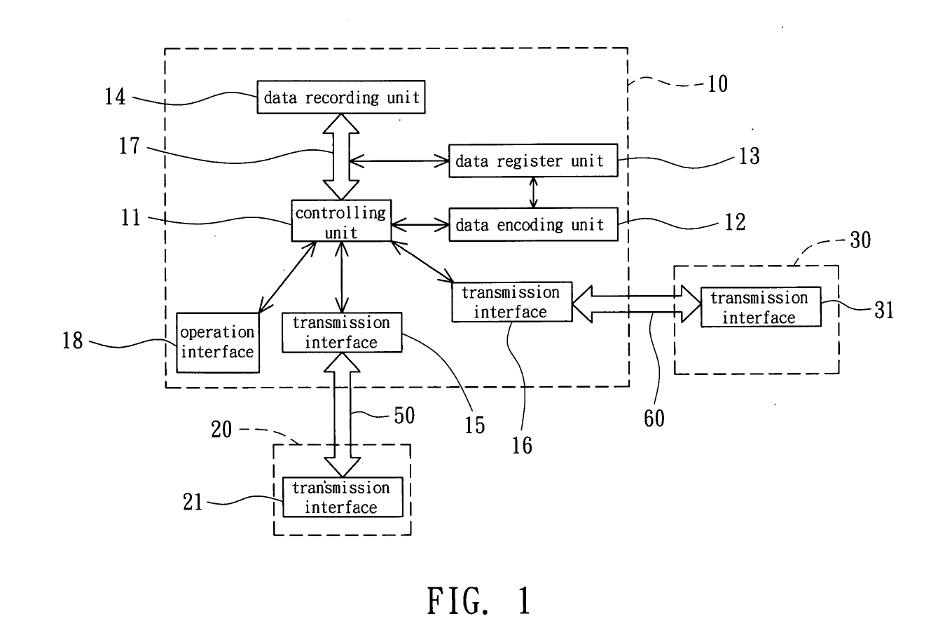

Referring to FIG. 1, a circuit diagram of an optical disc recordable drive and electronic device according to a preferred embodiment of the invention is shown. In FIG. 1, optical disc recordable drive 10 at least includes a controlling unit 11, a data encoding unit 12, a data register unit 13, a data recording unit 14, an operation interface 18 and transmission interfaces 15 and 16. When the transmission interface 15 is coupled with a transmission interface 21 of an electronic device 20, the user can record the data of the electronic device 20 onto an optical disc via the optical disc recordable drive 10. The transmission interface 15 is coupled to the transmission interface 21 via a plug/unplug connection or a data transmission cable 50. When the transmission interface 16 is coupled with a transmission interface 31 of a computer 30, the user can control the optical disc recordable drive 10 via the computer 30. The transmission interface 16 is coupled with the transmission interface 31 via a data transmission cable 60 in a plug/unplug way. The operation interface 18 is deposited on the surface of the casing of the optical disc recordable drive 10 to be activated to output a data recording command to the controlling unit 11. The controlling unit 11 is for controlling the operation of the data encoding unit 12, the data storage unit 13 and the data recording unit 14, the controlling unit 11 and the data recording unit 14 are mutually electrically connected via a IDE bus, while the controlling unit 11 can be a system on chip (SOC) bridging the IDE to the transmission interface 15 and 16 or a microprocessor for instance.

When the optical disc recordable drive 10 is coupled with the electronic device 20, the controlling unit 11 will automatically detect the first data of the electronic device 20. When the user activates the operation interface 18, the operation interface 18 will output a data recording command to the controlling unit 11. When the controlling unit 11 receives the data recording command outputted by the operation interface 13, first of all, the controlling unit 11 will control the electronic device 20 to output the first data to the data encoding unit 12. Next, the controlling unit 11 will control the data encoding unit 12 to code the first data and accordingly output a second data to the data register unit 13. After that, the data register unit 13 will receive and store the second data. At last, the controlling unit 11 will control the data recording unit 14 to record the second data stored in the data register unit 13 onto an optical disc.

Besides, a protocol can be agreed between the optical disc recordable drive 10 and the electronic device 20, so that the user can control the optical disc recordable drive 10 via the electronic device 20. Firstly, the user activates a data recording command to the electronic device 20 so that the electronic device 20 outputs the first data to the optical disc recordable drive 10, or the optical disc recordable drive 10 fetches the first data of the electronic device 20. Next, the optical disc recordable drive 10 will code and record the received or fetched first data onto the optical disc.

The controlling unit 11 according to the preferred embodiment has a data recording controlling program for controlling the recording to the data recording unit 14. Besides, the data recording controlling program can be stored in a program storage unit such as a hard disc or a flash read only memory (Flash ROM).

However, anyone who understands the technology of the invention will realize that the technology of the invention is not limited thereto. For example, the transmission interfaces 15 and 31 are two universal serial bus (USB) host interfaces or two Serial ATA host interfaces, while the transmission interfaces 26 and 21 are two USB client interfaces or two Serial ATA client interfaces. Besides, the transmission interfaces 15 and 16 can be integrated into an IEEE 1394 interface, while the transmission interfaces 21 and 31 are two IEEE 1394 interfaces. Besides, the operation interface 13 is a press-key or a touch panel, while the data register unit 12 is a hard disc or a random access memory (RAM). The electronic device 20 can be selected from the group consisting of a digital camera, a digital video recorder, a personal digital assistant, a handy drive, a voice recording ink pen, a MP3 player, and a mobile phone. The optical disc recordable drive 10 can be selected from the group consisting of a CD-R, a DVD-R, a DVD+R, a CD-RW, a DVD-RW, a DVD+RW and a DVD-RAM, while the data encoding unit 12 is a Mpeg2 coder or a Mpeg coder. Generally speaking, if the optical disc is a CD-R disc, the data encoding unit 12 inside the optical disc recordable drive 10 will code the first data into a data complying with Mpeg format. To the contrary, is the optical disc is a DVD-R disc, the data encoding unit 12 inside the Optical disc recordable drive 10 will code the first data into a data complying with Mpeg2 format.

The optical disc recordable drive disclosed in the above preferred embodiment of the invention has the design of coupling with an electronic device via a plug/unplug type transmission interface such as a USB or IEEE 1394, which is free of complicated design like a computer has and enables the user to back-up data whenever and wherever the user would like to.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An optical disc recordable drive comprising:
a first transmission interface for coupling with a second transmission interface of an electronic device;
a data encoding unit for coding a first data outputted by the electronic device and accordingly outputting a second data;
a data register unit for storing the second data outputted by the data encoding unit;
a data recording unit for recording the second data stored in the data register unit onto an optical disc; and
a controlling unit for controlling the electronic device to output the first data to the data encoding unit and controlling the operation of the data encoding unit, the data register unit and the data recording unit.

2. The optical disc recordable drive according to claim 1, wherein the first transmission interface is a universal serial bus (USB) host interface, and the second transmission interface is a USB client interface.

3. The optical disc recordable drive according to claim 1, wherein the first transmission interface and the second transmission interface are two first IEEE 1394 interfaces.

4. The optical disc recordable drive according to claim 3, wherein the first IEEE 1394 interface of the optical disc recordable drive is coupled with a second IEEE 1394 interface of a computer.

5. The optical disc recordable drive according to claim 1, wherein the first transmission interface is a Serial ATA host interface, the second transmission interface is a Serial ATA client interface.

6. The optical disc recordable drive according to claim 1, further comprising:
an operation interface for being activated to output a data recording command to the controlling unit, wherein the controlling unit controls the electronic device to output the first data to the data encoding unit and controls the operation of the data encoding unit, the data register unit and the data recording unit on receiving the data recording command when the controlling unit receives the data recording command.

7. The optical disc recordable drive according to claim 6, wherein the operation interface is a press-key.

8. The optical disc recordable drive according to claim 6, wherein the operation interface is a touch panel.

9. The optical disc recordable drive according to claim 1, wherein the data register unit is a random access memory (RAM).

10. The optical disc recordable drive according to claim 1, wherein the electronic device can be selected from the group consisting of a digital camera, a digital video recorder, a personal digital assistant, a handy drive, a voice recording ink pen, a MP3 player, and a mobile phone.

11. The optical disc recordable drive according to claim 1, further comprising:
a third transmission interface for coupling with a fourth transmission interface of a computer.

12. The optical disc recordable drive according to claim 11, wherein the fourth transmission interface is a USB host interface, while the third transmission interface is a USB client interface.

13. The optical disc recordable drive according to claim 11, wherein the fourth transmission interface is a Serial ATA host interface, while the third transmission interface is a Serial ATA client interface.

14. The optical disc recordable drive according to claim 1, wherein the data encoding unit is a Mpeg2 coder or a Mpeg coder.

15. An optical disc recordable drive comprising:
a first transmission interface for coupling with a second transmission interface of an electronic device via a protocol, so that a user can control the optical disc recordable drive via the electronic device;
a data encoding unit for coding a first data outputted by the electronic device and accordingly outputting a second data;
a data register unit for storing the second data outputted by the data encoding unit;
a data recording unit for recording the second data stored in the data register unit onto an optical disc; and
a controlling unit for controlling the operation of the data encoding unit, the data register unit and the data recording unit;
wherein the user controls the optical disc recordable drive via the electronic device, so that the optical disc recordable drive can code and record the second data outputted by the electronic device onto an optical disc.

16. The optical disc recordable drive according to claim 15, wherein the first transmission interface is a USB host interface, while the second transmission interface is a USB client interface.

17. The optical disc recordable drive according to claim 15, wherein the first transmission interface and the second transmission interface are two first IEEE 1394 interfaces.

18. The optical disc recordable drive according to claim 17, wherein the first IEEE 1394 interface of the optical disc recordable drive is coupled with a second IEEE 1394 interface of a computer.

19. The optical disc recordable drive according to claim 15, further comprising:
a third transmission interface for coupling with a fourth transmission interface of a computer.

20. The optical disc recordable drive according to claim 15, wherein the fourth transmission interface is a USB host interface, while the third transmission interface is a USB client interface.
